(19) United States
(12) Patent Application Publication
(10) Pub. No.: US 2002/0122310 A1
(43) Pub. Date: Sep. 5, 2002

(54) High intensity discharge lamp

(76) Inventors: Timothy DiPenti, Russell, PA (US); Philip C. Roller, Ashville, NY (US)

Correspondence Address: Byron A. Bilicki, Esq., The Bilicki Law Firm, P.C., Furniture Mart Building, Suite 1000, 111 West Second Street, Jamestown, NY, 14701, US

(21) Appl. No.: 09/956,200

(22) Filed: Sep. 18, 2001

Related U.S. Application Data
(60) Provisional application No. 60/233,146, filed on Sep. 18, 2000.

(51) Int. Cl. F21V 17/02; F21V 13/12

(52) U.S. Cl. 362/512; 362/281; 362/319; 362/539; 362/299

(57) ABSTRACT

A vehicle lamp unit is disclosed that utilizes a high intensity discharge bulb for high beam, low beam and fog/driving lamps. The lamp uses reflectors and shields to selectively block light emitted from the HID bulb and to direct the light into a desired pattern. A control device is utilized to move the shields into various desired light blocking positions. Lamps of various shapes can be fabricated using the shield system by using optics to direct light into diverse preferred patterns.

### PRIORITY STATEMENT

This application claims the benefit of U.S. Provisional Application No. 60/233,146 filed Sep. 18, 2000.

### FIELD OF INVENTION

The present invention is related to a lamp for vehicles, more particularly, a lamp that utilizes gas discharge bulbs as the light source for the lamp.

### BACKGROUND OF THE INVENTION

High intensity discharge (HID) lamps are used for various applications, such as high bay lighting for industrial environments, outdoor floodlighting and roadway lighting. However, because of the characteristics of the HID bulbs, these types of bulbs have not been practical for use in vehicles. HID bulbs are similar to incandescent bulbs in that a light is generated between two electrodes; however, HID bulbs create an arc while incandescent bulbs heat a filament to incandescence. The arc in a HID bulb is shorter, yet it will generate greater light, heat and pressure within the arc tube. There are three types of HID bulbs, typically used: mercury vapor, metal halide and high pressure sodium. Mercury vapor bulbs consist of a mercury-vapor arc tube with tungsten electrodes at both ends. The arc tube is filled with high purity mercury and argon gas and is enclosed within an outer bulb, which is filled with nitrogen. In a metal halide bulb, metal halides are added to the arc tube in addition to the mercury, argon or xenon gases. The arc tube gaseous mixture is then ignited with a high voltage to reach a critical temperature. The gases are ignited with two metal electrodes, usually tungsten electrodes. When high voltage is applied, an arc is created between the two electrodes. Once the critical temperature is reached the chemicals or gases ionize and vaporize the metal halides. A high pressure sodium bulb has an arc tube that is made of a ceramic material and is filled with xenon and a sodium-mercury gas mixture to create the arc. The high pressure sodium bulbs do not typically have starting electrodes, as the xenon in the arc tube can act as a starting material.

HID bulbs have a long life, a high lumen output per watt, and are small in size. In addition, HID bulbs are sturdier than incandescent bulbs since the arc is not as susceptible to damage as the filaments of an incandescent bulb. Further, the HID bulbs can draw less amperage than halogen bulbs. Also, HID bulbs produce less heat than halogen bulbs, requiring less heat sinking around vehicular lamps, conserving space.

There are drawbacks associated with the use of HID bulbs. Firstly, HID bulbs require time to warm up, from 15 seconds up to 6 minutes. Secondly, HID lamps have a “restrike” time. A momentary interruption of current or a voltage drop too low to maintain the arc will extinguish the lamp. At that point, the gases are too hot to ionize and must be allowed to cool down in order to allow the arc to restrike. Restriking can take up to 15 minutes, depending on which HID source is being used. Thirdly, operating an HID bulb intermittently shortens the life of the bulb. Thus, once an HID bulb is on; it is more practical to leave a HID bulb on. Lastly, the intensity of the arc of the HID bulb is easily changed or altered. Because of this, a headlamp using a HID bulb cannot function both as a high beam lamp and a low beam lamp. This inability to function as dual high/low beam lamp disallows the cost efficient use of high intensity bulbs as light sources for headlamps.

### SUMMARY OF THE INVENTION

The present invention solves the above mentioned limitations of the previous designs in a cost-effective manner by utilizing a single HID bulb in conjunction with a reflector with a smooth interior and optics to facilitate appropriate light distribution, a lens, a shield and a device for controlling the movement of the shield remotely. An HID bulb has a high voltage arc that functions in approximately the same way that a filament functions in an incandescent bulb. However, the arc in the HID bulb produces a greater intensity of light and will last longer than an incandescent bulb. In addition, the arc of the discharge bulb, because of the point of light produced by the arc, allows for greater accuracy of the predicted pattern of the light produced by the discharge bulb. The reflector has an interior area and an exterior area. The reflector has a first portion that is, preferably, shaped like a parabola. This first portion extends around the sides of the HID bulb. The reflector has a second portion, with two horizontal members that meet the edges of the first portion. The reflector has two openings in the first portion; one where the HID bulb is located such that the bulb extends from the exterior portion of the reflector to the interior. The arc of the HID bulb is located in the interior portion of the reflector. The second hole encloses the arm that is connected to the shield and to the control device. The arm passes from the exterior to the interior. The shield is located in the interior portion of the reflector such that, when moved into a position relative to the HID bulb, the shield will prevent light from being reflected from the reflector towards the lens and subsequently emitted from the lamp. In the first position, the lamp will function as a high beam lamp, since the shield is not blocking any light. In the second position, the lamps will function as a low beam lamp, since the shield is blocking the light.

The shield of the present invention can also be used to create additional functionality for the lamp, in the form of a fog/driving lamp. The shield can be located at any point around the circumference of the first portion of the reflector. In one preferred embodiment, the shield encircles the discharge bulb approximately halfway, creating a semi-circle around one half of the bulb. In a second preferred embodiment, two shields, one above and one below the bulb, encircle the discharge bulb approximately halfway. The combination of the two shields completely encircles the discharge bulb. The control device is located on the exterior of the reflector and is operatively arranged to engage and control the movement of the arm.

The lens is arranged in the reflector such that the lens encapsulates the shield and discharge bulb in the reflector. The first portion of the reflector has optical elements on its inner surface. These optical elements create sections on the inner surface of the first portion of the reflector. The second portion of the reflector also has optical elements on both horizontal members. In the one embodiment, one of the horizontal members has large and wide ridges on its inner surface of the member and the second has smaller, very fine ridges created on the inner surface of the member. It should be noted that there are many different arrangements of optics in terms of shapes and sizes that will accomplish the goal of distributing the light. The optical elements further assist in the distribution of light over the desired range of angles for light distribution. The lens can possess additional optics to spread the light emitted from the HID bulb.

### OBJECTS OF THE INVENTION

Accordingly, it is an object of the present invention to provide a high/low beam headlamp for a vehicle that utilizes a HID bulb.

It is an additional object of the present invention to provide a headlamp, utilizing an HID bulb that can also function as a driving or a fog lamp.

Further, it is an object of the present invention to provide a plurality of shields in three positions and a segmented reflector that allows the lamp to function as a high beam lamp, low beam lamp and fog lamp.

These above mentioned characteristics and other objects of the invention will become more apparent from the following description of the preferred embodiments.

### BRIEF DESCRIPTION OF THE DRAWINGS

Other aspects, objects, and advantages of the present invention appear more clearly on reading the following best mode for carrying out the invention, given by way of example and made with reference to the accompanying drawings, in which:

FIG. 1 is cross sectional side view of the lamp of the present invention, with the shield in the first position relative to the discharge bulb.

FIG. 2 is a cross sectional side view of the lamp of the present invention, with the shield in the second position relative to the discharge bulb.

FIG. 3 is a front view of the reflector, the discharge bulb and the shield of the present invention.

FIG. 4A is cross sectional side view of an alternative embodiment of the present invention, with the first shield in the second position relative to the discharge bulb and a second shield positioned away from the arc of the discharge bulb.

FIG. 4B is a cross sectional view of an alternative embodiment of the present invention with first shield and second shield in the second position relative to the arc of the discharge bulb.

FIG. 5A is a front perspective view of an alternative embodiment of the present invention, with the first shield in the second position relative to the discharge bulb and a second shield positioned away from the arc of the discharge bulb.

FIG. 5B is a front perspective view of an alternative embodiment of the present invention, with the first shield and second shield in the second position relative to the arc.

### BEST MODE FOR CARRYING OUT THE INVENTION

For the purpose of promoting an understanding of the present invention, reference will be made to the present invention as illustrated in the drawings. It will nevertheless be understood that no limitations of the scope of the invention is thereby intended, such alterations as using could provide additional alterations which would fall within the spirit and scope of the invention described herein. Some of the possible alterations will be mentioned in the following description.

The drawings will be described in detail. For the ease of the reader, like reference numerals designating identical or similar part will remain consistent through the drawings.

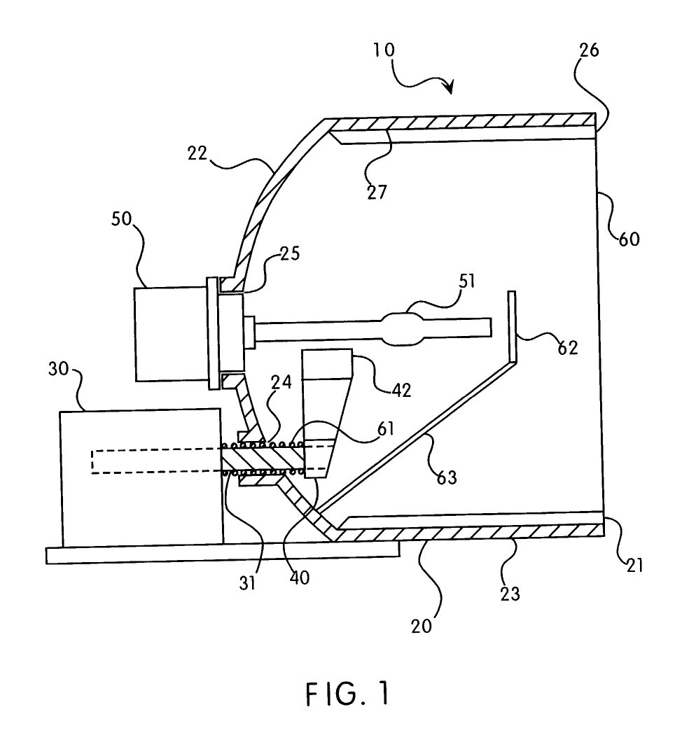

FIG. 1 shows a cross sectional side view of the preferred embodiment of the present invention. The reflector 20 has a first portion 22 that is, preferably, shaped like a parabola. This first portion 22 extends around the sides of the lamp. The reflector 20 also has a second portion 23 and 27, which are substantially horizontal members that meet the edges of the first portion 22. The reflector has two openings 24 and 25 in the first portion 22; the first opening 25 houses the HID bulb 50 and allows the HID bulb 50 to extend through the reflector 20 such that the arc tube 51 of the HID bulb 50 is located in the interior of the reflector 20. The second opening 24 encloses the arm 31 that is connected to the shield 40 and to the control device 30. The arm 31 also passes through the reflector 20 such that a portion of the arm 31 is located on either side of the first portion 22 of the reflector.

The lens 60 extends between the first portion 22 and the second portion 23 and 27 to cover and encloses the shield and the HID bulb. FIG. 1 shows the shield 40 in a first position. The first position is pulled back behind the arc tube 51 of the HID bulb 50. When the shield 40 is in the first position, all of the light emitted from the HID bulb 50 is reflected toward the lens 60 and emitted from the lamp. The control device 30 operatively engages the arm 31 of the present invention to move the shield 40 from the first position to the second position. The control device 30 is, preferably, an electromechanical device that can be controlled remotely by the driver of the vehicle. Persons of ordinary skill in the art will recognize the control device 30 can be one of several types of actuators that can mechanically move arm 31 upon receipt of an electrical signal such as would be received from a driver. The control device 30 is located separate from the reflector but close enough to the reflector to control the arm 31 of the lamp. It should be understood that the control device could be located in any position near the lamp such that the control device engages the arm to control the movement of the shield. In addition, in a most preferred embodiment, a spring 61 can be utilized around the arm 31 to bias the shield in one position.

FIG. 1 also depicts reflector 62 positioned in front of bulb 50. Light emitted from arc 51 directly toward lens 60 is reflected by reflector 62. Reflector 62 is supported by holding member 63 which is attached to reflector 62. Persons of ordinary skill in the art will recognize that reflector 62 can be supported by alternate methods such a directed placement on the lens 60 or suspension between a plurality of supporting structures.

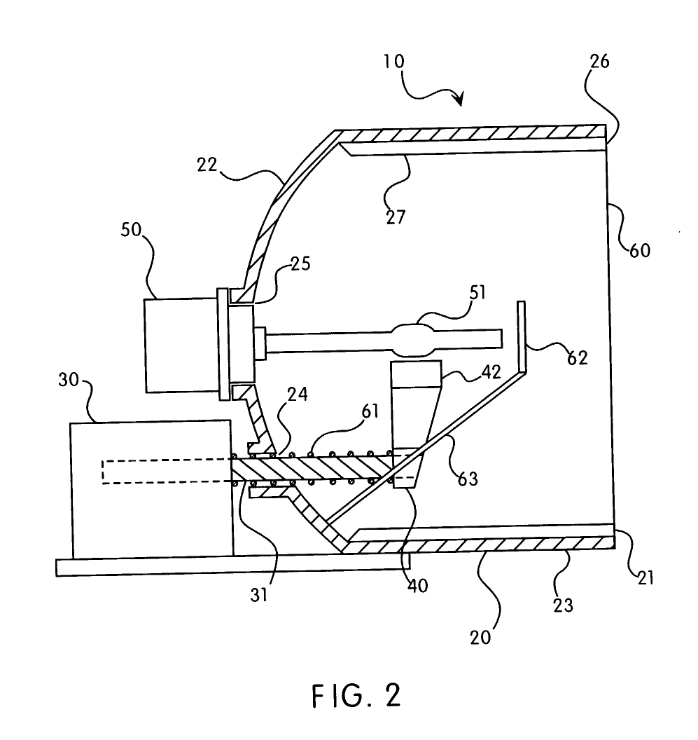

FIG. 2 shows the shield 40 in a second position. The second position is located such that the shield is near the arc tube 51 of the HID bulb 50. When the shield 40 is in the second position, substantially half of the light emitted from the HID bulb 50 is blocked from reaching of the bottom segment of reflector portion 22 and horizontal member 23. Consequently, the blocked light is prevented from being emitted from the lamp 10.

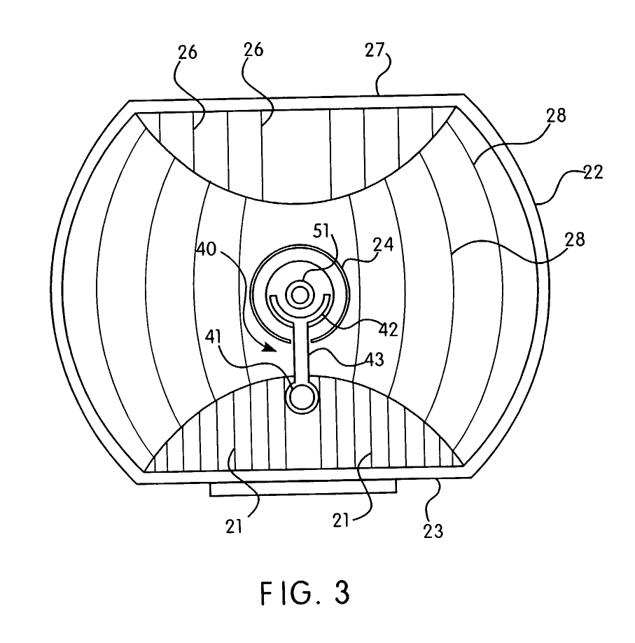

As seen in FIG. 3, the first portion of the reflector has optical elements on its inner surface. These optical elements create sections on the inner surface of the first portion of the reflector (not shown in the figures). The horizontal members 23 and 27 of the reflector 20 also have optics, 21 and 26, respectively, on both horizontal members. In one embodiment the optics of horizontal member 27 has large and wide ridges 21 on the inner surface and the optics of horizontal member 23 has smaller, very fine ridges 26 on the inner surface. The optics further assist in the distribution of light over the desired range of angles for light distribution. In an alternate embodiment, the lens can possess additional optics to spread the light emitted from the HID bulb.

FIG. 3 also shows a front view of the shield and the HID bulb of the present invention. The shield 40 comprises a blocking member 42, a support member 43, and an attachment member 41. In the preferred embodiment, the blocking member 42 is a half circle. When the shield 40 is in the second position the blocking member 42, surrounds the arc tube 51 to prevent the light from reaching the reflector. The support member 43 holds up the blocking member 42 and is fixedly secured to the arm 31 through the attachment member 41.

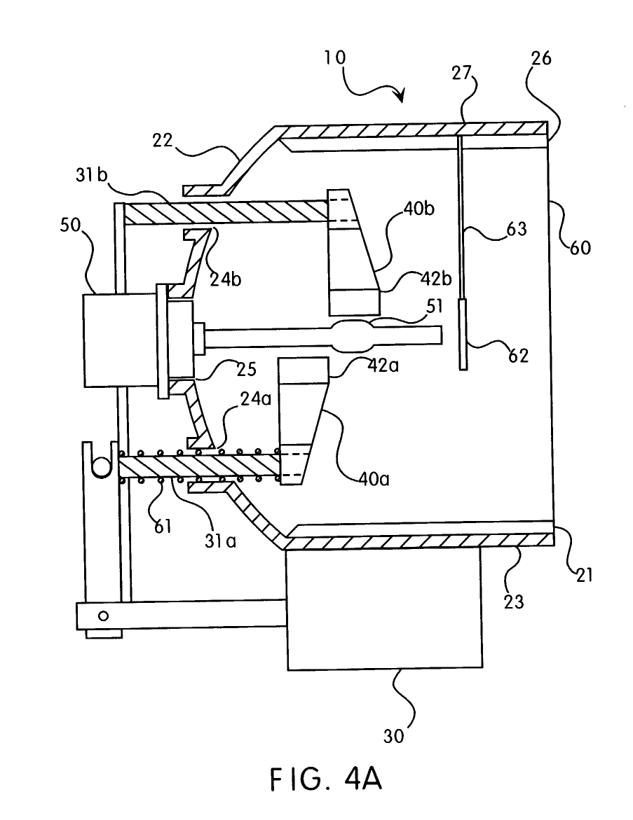

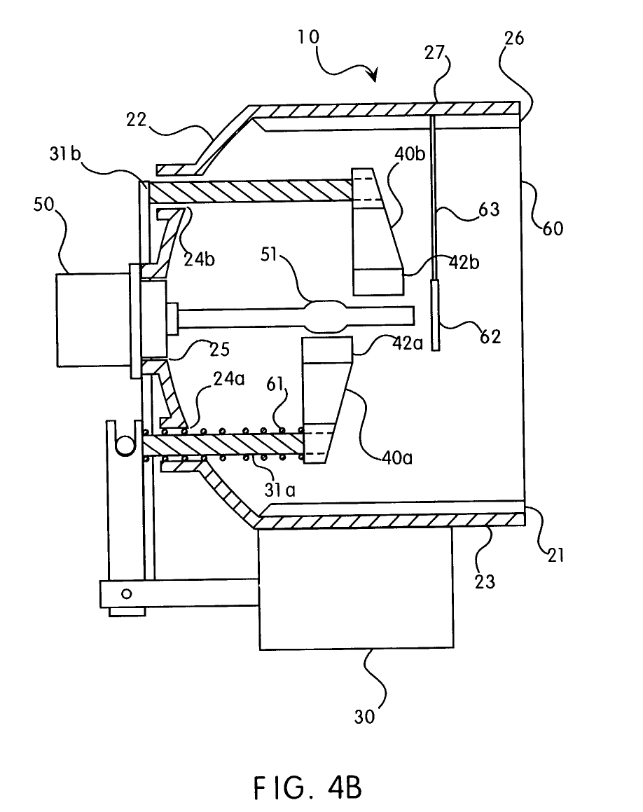

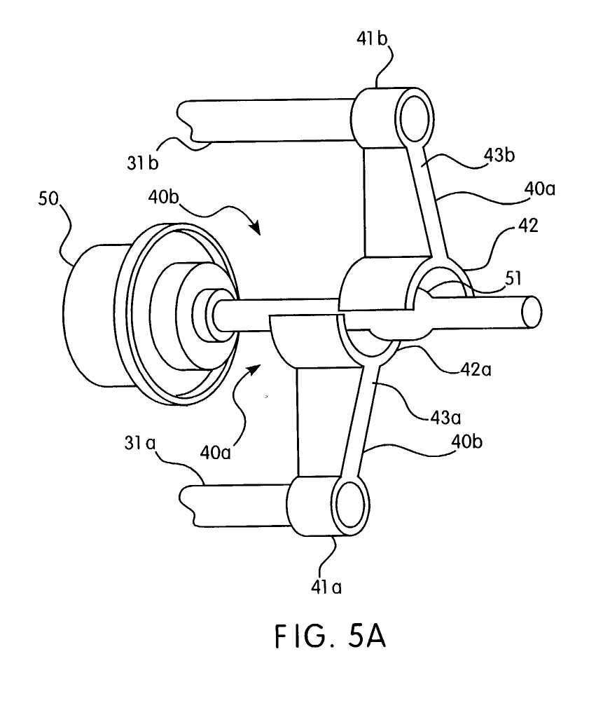

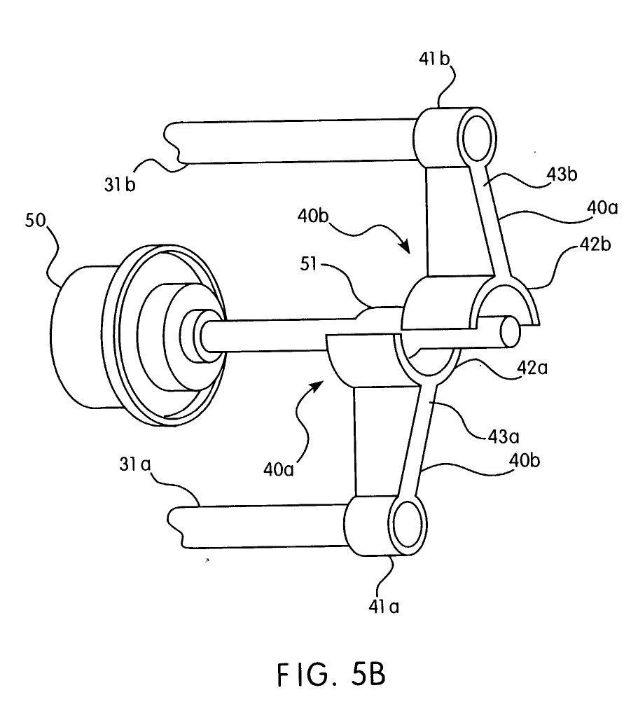

FIG. 4 depicts an alternative embodiment of the present invention. In the alternative embodiment, the first portion 22 of the reflector 20 has three openings, opening 25 for the HID bulb 50 and openings 24a and 24b for the arms 31a and 31b respectively, that assist in the control of the movement of the shields 40a and 40b. As shown in FIG. 4B and in FIG. 5B, the alternative embodiment of the present invention utilizes two shields 40a and 40b, one located below the HID bulb 50 and one located above bulb 50. FIG. 5A shows a front perspective view of the two shields 40a and 40b and the HID bulb 50. In FIG. 5A, shield 40a is in the second or blocking position and shield 40b is in the first or unblocking position. FIG. 5B shows shields 40a and 40b in the blocking position relative to bulb arc 51. Each of the shields 40A and 40b has a blocking member 42a and 42b, a support member 43a and 43b, and an attachment member 41a and 41b, respectively. Again, the support member 43 holds the blocking member 42 and is fixedly secured to the arm 31 through the attachment member 41.

,As depicted in FIG. 4A and 4B, an alternative placement of the control device 30 is shown. As one or ordinary skill in the art will recognize, various alterations to the arm 31 of the present invention can be made based upon the location of the control device. FIGS. 4A and 4B depict one such solution to the arm; however, many other solutions can be utilized and would work equally well with the control device to control the movement of the arms 31a and 31b. In addition, in a most preferred embodiment, a spring 61 can be utilized around the arm 31a and 31b to bias the shield in one position.

The description presented in the preferred embodiments is not intended to demonstrate all of the possible arrangements and modifications to the design. For those skilled in the art, changes will be apparent that will fall within the scope of the present invention.

What is claimed:

1. A headlamp unit comprising:
a high intensity discharge light bulb said bulb having an arc;
a reflector, substantially parabolic in shape adapted to receive said bulb, said reflector having optics to spread said light; and,
a lens attached to said reflector.

2. The lamp according to claim 1 further comprising a second reflector to reflect said light emitted directly toward said lens.

3. A headlamp unit comprising:
a high intensity discharge light bulb, said bulb having an arc;
a reflector, substantially parabolic in shape, adapted to receive said bulb, said reflector having optics to spread said light;
a shield adjacent to said arc; and,
a lens attached to said reflector.

4. The lamp according to claim 3 wherein said shield comprises a blocking member, a support member and an attachment member.

5. The lamp according to claim 4 wherein said blocking member is a substantially half circle.

6. The lamp according to claim 3 further comprising a spring to hold said shield in one position.

7. The lamp according to claim 3 further comprising a second reflector to reflect said light emitted directly toward said lens.

8. A headlamp unit comprising:
a high intensity discharge light bulb, said bulb having an arc;
a controller;
a shield operatively attached to said controller and adapted to block said light from said arc;
a reflector, substantially parabolic in shape, adapted to receive said high intensity discharge bulb and said shield, said reflector having optics to spread light; and,
a lens attached to said reflector.

9. The lamp according to claim 8 wherein said shield comprises a blocking member, a support member and an attachment member.

10. The lamp according to claim 9 wherein said blocking member is a substantially half circle.

11. The lamp according to claim 8 further comprising a spring to hold said shield in one position.

12. The lamp according to claim 8 further comprising a second reflector to reflect said light emitted from said arc directly toward said lens.

13. A head lamp comprising:
a high intensity discharge light bulb, said bulb having an arc;
a plurality of shields, said plurality of shields adjacent to said arc and adapted to block said light form said arc;
a reflector, adapted to receive said light bulb and said plurality of shields, said reflector having optics to spread said light; and,
a lens attached to said reflector.

14. The lamp according to claim 13 wherein each of said plurality of shields comprises a blocking member, a support member and an attachment member.

15. The lamp according to claim 14 wherein said blocking member is a substantially half circle.

16. The lamp according to claim 13 further comprising a spring to hold said each of said plurality of shields in one position.

17. The lamp according to claim 13 further comprising a second reflector to reflect said light emitted from said arc directly toward said lens.

18. A headlamp unit comprising:
a high intensity discharge light bulb, said bulb having an arc;
a plurality of shields each of said plurality of shield adapted to block said light from said arc;
a controller operatively attached to each of said plurality of shields;
a reflector, substantially parabolic in shape, said reflector operatively adapted to receive said light bulb and said plurality of shields, said reflector having optics to spread said light; and,
a lens attached to said reflector.

19. The lamp according to claim 18 wherein each of said plurality of shields comprises a blocking member, a support member and an attachment member.

20. The lamp according to claim 19 wherein said blocking member is a substantially half circle.

21. The lamp according to claim 18 further comprising a spring to hold said each of said plurality of shields in one position.

22. The lamp according to claim 18 further comprising a second reflector to reflect said light emitted from said arc directly toward said lens.
